(19) United States
(12) Patent Application Publication
(10) Pub. No.: US 2009/0020982 A1
(43) Pub. Date: Jan. 22, 2009

(54) Trailer steering mechanism

(76) Inventor: Stephen S. Buckingham, Springfield, VT (US)

Correspondence Address: Stephen S. Buckingham, 52 Griswold Dr., Bellows Falls, VT, 05101, US

(21) Appl. No.: 11/879,132

(22) Filed: Jul. 16, 2007

(51) Int. Cl. B62D 13/02

(52) U.S. Cl. 280/426

(57) ABSTRACT

A mechanism for steering one or more axles of a multi-axle trailer and cutting the air supply to the air suspension system on some of said axles when the steering mechanism cannot match the angle of the tractor by utilizing cams keyed to the tractor fifth wheel.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

This invention is a steering device for highway semi-trailers.

2. Prior Art

Tractor trailer trucks are subject to stringent weight requirements. Generally in North America trucks are restricted to 80,000 pounds total weight, with 12,000 pounds allowed on the tractor front axle and 34,000 pounds allowed on each tandem set on the tractor and the trailer. On a single axle (not part of a tandem set) with dual or so-called “super single” tires the limit is 20,000 pounds. This means that the load must be exactly distributed on a typical 5 axle tractor-trailer combination in order to get maximum load on the truck but not exceed the axle limits. To alleviate this problem so-called “spread axle” trailers have been introduced which, by having at least 10 feet between the two axles, allow them to be treated as two individual axles instead of a tandem set, and thus allows for 40,000 pounds on the trailer axles instead of 34,000. This allows for much more flexibility in loading and removes the necessity for the driver to weigh each load to make sure the axle limits are not exceeded. The penalty for this arrangement is that when the truck makes a corner there is considerable scrubbing of the tires, causing excessive wear and inducing very high stress on the trailer suspension and frame. Driving these trucks also presents problems, especially in backing, as it is never certain which axle will control the trailer and which will skid. Another issue is that in slippery conditions the trailer will tend to push the tractor straight ahead when the tractor starts to turn, aggravating any jackknifing tendency that may exist.

There have been several attempts to solve this problem, but none have been widely accepted commercially. The simplest solution would be to have one axle straight and the other a free steering axle; this is used often for auxiliary axles on tractors. This is undesirable in this case, as the free steering axle would be very hazardous in slippery conditions, greatly increasing the chance of jackknifing. It probably for this reason would be unacceptable to most state motor vehicle authorities. In fact, there have been attempts to provide a steering mechanism for one axle of a tandem axle trailer long before spread axle trailers came into common use.

One such attempt is explained in U.S. Pat. No. 2,359,978 to Edwards on Oct. 10, 1944. This is a straightforward design utilizing a mechanical linkage keyed off of the fifth wheel of the tractor. It has one fatal flaw, however, in that it has no provision for the angle between the tractor and the trailer to exceed the angle that the steering mechanism can follow. There will be many situations in tight maneuvering where that angle is exceeded, especially when backing, which will damage or destroy the mechanism. This is also one problem with U.S. Pat. No. 3,930,669 to Kollander et al. On Jan. 6, 1976.

Another very different approach is illustrated by U.S. Pat. No. 3,591,203 to Steiner on Jul. 6, 1971. This utilizes hydraulic actuators operated by a cam controlled by the angle at the fifth wheel to rotate the rear axle on a turntable by hydraulic cylinders. This presents several problems: first, any hydraulic system sooner or later will leak, which will cause this system to have slop and lose alignment; second, by having the rear axle mounted on a turntable at maximum turning the wheels are in effect closer together in respect to the width of the trailer, reducing stability (an effect with which anyone who has pulled a child's wagon will be familiar); and finally, by having the entire axle on a turntable the frame of the trailer must be above said turntable and must be narrow enough for the wheels to not hit it at their maximum angle, which will compromise the depth and stability of the frame. A similar concept, this time using cables instead of hydraulics is shown in U.S. Pat. No. 3,689,107 to Humes on Sep. 5, 1972. This avoids the objection of hydraulics but has the same problem of axles mounted on turntables. The objections to hydraulics also apply to U.S. Pat. No. 4,982,976 to Kramer on Jan. 8, 1991.

U.S. Pat. No. 5,026,085 to Ducote on Jun. 25, 1991 offers two approaches to this problem. The first (which is the subject of other patents by Ducote) senses the angle of the trailer to the tractor electrically through a position sensor, which will then control an electronic device to steer one or more axles. The second utilizes a sector gear and pinion to sense the angle of the tractor to the trailer and steer the axle(s) accordingly. The first approach, while able to deal with the angle of the tractor to trailer exceeding the steering angle limit has two overwhelming problems. The first is that the environment of a highway trailer is just about the most unfriendly possible for any sort of electronic device, due to moisture, dirt, and salt as well as slush and snow. This is exemplified by the difficulty truckers experience in keeping all the lights on the trailer working. The second is that it requires an electrical power supply, which means either one must be provided by the tractor or the trailer must have its own. Since the standard connections to a road trailer do not include a constant power source, this means that tractors to haul these trailers would have to be modified. Having a self contained power source on the trailer would be excessively costly. The sector gear approach has the same problem noted on the first patents cited, namely that it cannot accommodate angles between the tractor and trailer exceeding the steering angle.

### BACKGROUND OF THE INVENTIONS—OBJECTS AND ADVANTAGES

In order for a steering mechanism for highway trailers to be commercially viable, this inventor feels that it must satisfy the following criteria. First, it must be compatible with existing tractors with no modifications. Second, it must be able to tolerate angles between the tractor and trailer exceeding 90 degrees. Third, it must allow the turning wheels to turn to an adequate angle without requiring the frame rails to be placed closer together. Fourth, it must be totally reliable, requiring a minimum of maintenance. One aspect that none of the prior art inventions addresses is the necessity of providing for air brake actuators which must be fitted so as to not interfere with the turning action or turning mechanism of the axle and still not hit the frame of the trailer when turned. Present art semitrailers and tractors use so-called S-cam air brakes exclusively on drive and trailer axles, which consist of a brake drum, two shoes, a cam shaped like the letter “S” (thereby giving it the name) which when rotated presses the brake shoes against the inside diameter of the brake drum. Rotation of the cam is provided by attaching an arm to the shaft of the cam and applying a force by an air chamber at the end of the arm. This causes rotation of the cam shaft, and when air is released from the air chamber springs on the brake shoes cause the cam to rotate back, and return the actuating arm to its original position. Since the angle that the air chamber can move the arm is relatively small, and as the shoes will wear with use the actuating arm is equipped with an adjusting device, formerly manually adjusted but now almost universally self-adjusting that causes the angle of the actuating arm to be matched with the wear of the brake shoes so that the actuating chamber can always rotate the cam far enough to provide maximum braking force. In the event of air loss, a second air chamber is provided on the actuating chamber, but this one is used to compress a powerful spring, which in the event of air loss will then extend and actuate the brake cam and apply the brakes. This is also used for parking by manually releasing the air in the safety chamber. Present regulations require that at least two wheels of a tractor and all wheels of a trailer that are continually on the ground have such safety brakes. These actuators, referred to hereafter as spring brake canisters, are quite large and on any steerable wheel must not interfere with the frame or suspension components of the trailer.

The present invention achieves these objectives by utilizing a cam mounted to a turntable which in turn is keyed to the fifth wheel of the tractor and turns relative to the trailer to match the angle between the tractor and trailer. In the preferred embodiment this cam then activates a pair of cables that then steer the steering axle or axles. The cam is contoured so as to steer the axle as far as the axle will go and then hold that angle; allowing the tractor to achieve any angle with the trailer necessary without straining or damaging any of the mechanism. An additional feature of this invention is that it incorporates a second cam that cuts the air to the suspension of the steering axle when the tractor-trailer angle exceeds the angle which the steering axle can follow, causing the trailer to act as a single axle trailer as the steering axle will drag but have no weight on it. Since this will only happen at slow speeds this is acceptable; many current spread axle trailers have valves to cut the air to one axle for maneuvering. Some of them are operated manually, which has the drawback of the possibility that the driver can forget to release the valve causing the trailer to go on the highway with the load on only one axle, which often ends with blown tires. There are also trailers that automatically release the valve when the trailer reaches a certain speed, usually about 10 MPH. On a trailer built on the principles of this present invention, the release valve would only engage when the tractor is at a greater angle to the trailer than the steering mechanism could follow, which with most applications would be about 45 degrees. This could only occur at very low speeds, creating no danger of blowing tires. In the case where three axles are used on the trailer and two are steered, it will normally only be acceptable to cut the air to one of the steering axles. If more than three axles are used it would be acceptable to cut the air to half of the steering axles, which would be the ones farthest from the fixed axle.

Two other features of this invention are significant. The first is the use of so-called “super single” tires for the steering axle. These are extra wide single tires that can carry the same load as normal dual tires used on highway trucks. By using “super singles” the turning angle of the steering wheels can be much greater without decreasing the frame width. Also, since a pair of ordinary single tires is quite a bit heavier than a “super single” the weight savings will help offset the added weight of the steering mechanism. The other feature is the brake arrangement for the wheels on the steering axle. Since trailers are required to have spring actuated brakes on all wheels, and the spring brake canisters are quite sizable, the problem of where and how to mount them on a steerable wheel is an issue that has not been addressed on any of the prior art inventions. This is not a problem on front axles, as they do not have spring actuated brakes, and the brake actuators are smaller diameter as well. The solution is to place the brake camshaft directly below the kingpin and offset the kingpin towards the top of the wheel and incorporate a universal joint into the camshaft, enabling the spring brake canisters to be mounted inboard on the axle where space is not a problem. The key point is that the center point of the universal joint is coincident with the extended centerline of the kingpin. This enables the wheel to turn to its limits and not affect the brake actuation.

Another advantage comes when applying spread axles to box trailers. With fixed axles it is necessary to add a heavy sub-frame to a box trailer in order not to overstress the structure when turning; this invention will allow using spread axles on box trailers without any additional reinforcement.

The only requirement for the tractor that would not be necessary for a conventional trailer is that the slot on the fifth wheel must be precisely aligned with the frame of the tractor in order to preserve the alignment of the wheels on the steering axle. A simple fixture can be built to aid in this, and would only need to be done once. It may be necessary, however, to disable the fifth wheel sliding mechanism and lock the fifth wheel in position, but since the fifth wheel slider is used to adjust weight distribution and the spread axles allow more flexibility in weight distribution this should not be a problem.

The preferred embodiment incorporates two axles, with the steerable axle located at the rear of the trailer and the fixed (i.e. non-steerable) axle located at least 10 feet in front of it. This is the same arrangement as most spread axle trailers in use today, but it will have significant advantages. First, tire and suspension wear will be considerably reduced, and fuel mileage will be increased. Second, the trailer will track on the fixed axle. A conventional spread axle trailer when going forward will track on the rear axle and skid the forward axle, which means that the track of the rearmost axle dictates the turn clearance, which in this case means the track is equivalent to a single axle trailer with the axle all the way at the rear of the trailer. By having the trailer track on the forward axle it will act like a single axle trailer only as long as to the fixed axle from the driver's perspective, making it much easier to turn sharp corners without clipping something on the inside of the turn with the trailer.

Another embodiment would have three axles with the fixed axle exactly in the middle, and two steerable axles equally spaced behind it. This would be the most maneuverable configuration possible, as the rear outside corner of the trailer would exactly track the path of the front outside corner on a turn. The rearmost axle would have the air to the suspension cut when its steering angle is exceeded, which would lead to scuffing on the tires of the other two axles in that situation. It would, however, be able to be drawn by a single axle tractor without sacrificing any load carrying ability, since it would have three axles under the trailer, each legally able to carry 20,000 pounds due to their being at least ten feet apart, assuming at least a forty foot trailer. However, this would require the load to be distributed with more weight towards the rear, as an even distribution would result in the tractor axle carrying more than 20,000 pounds. This embodiment would be ideal for dense urban areas, but for long distance transport it would probably be less desirable, since it would be less stable other embodiments at highway speed. It also has the disadvantage of requiring a separate cam for each steering axle, as they would steer to different angles and the rear one would run out of steerability before the intermediate one. This could be arranged by stacking a second cam on top of the first, or by having a secondary turntable operated by the cables from the first cam.

A third embodiment is to have three axles spaced so that the single axle of the tractor and all three trailer axles are equally spaced. This would result in a lighter overall arrangement, as the drive axle and interaxle differential that are no longer needed on the tractor would be considerably heavier than the trailer axle and steering mechanism. In this case the fixed trailer axle would be the middle one, and the rear trailer axle would be the one that would have its suspension air cut in tight turns. This arrangement has the advantage that one cam would be able to steer both axles, as the steering angles will be the same but in opposite directions. The disadvantage is that the single axle tractor would have less traction than a tandem axle tractor in slippery or bad road conditions.

### SUMMARY

In accordance with the present invention, a device to steer one or more axles on a highway semi-trailer with a cam keyed to the fifth wheel activating cables or other mechanisms to steer the steering axle(s) and a cam to activate an air valve which will cut the air to the steering axle, or half the steering axles if two or more are used, when the angle between the tractor and trailer exceeds the angle that the trailer can steer.

### DRAWINGS—FIGURES

FIG. 1 shows a plan view of a complete flatbed trailer less the deck (which is not shown in any of the figures.)

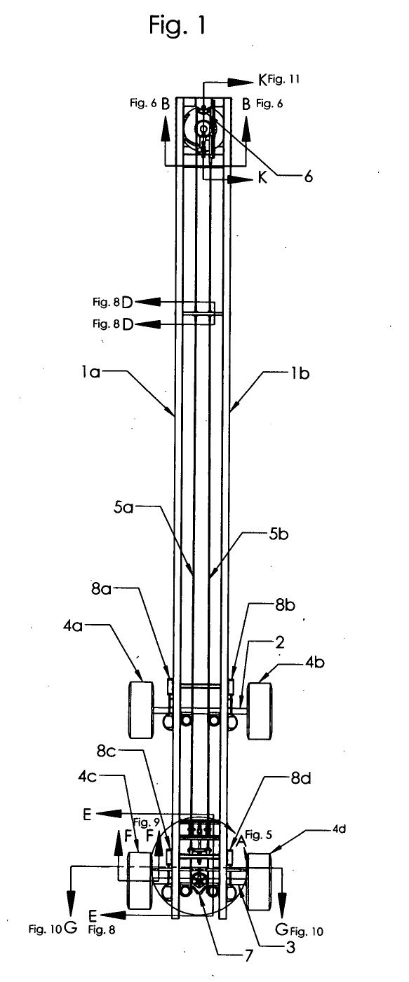

FIG. 2 shows a right side elevation of the complete trailer.

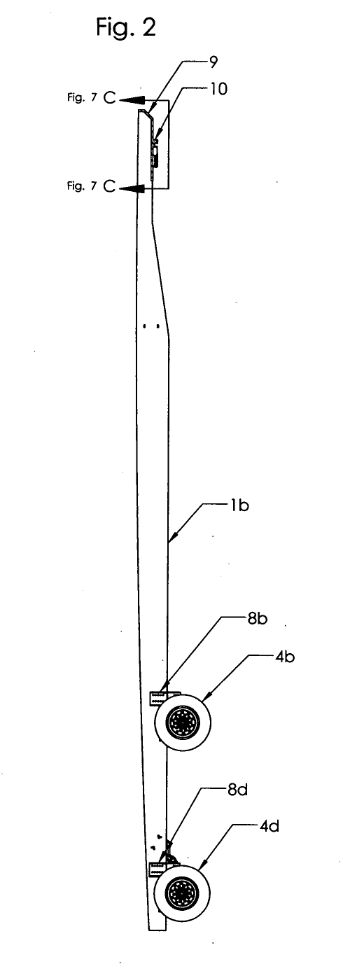

FIG. 3 shows a perspective view of the trailer.

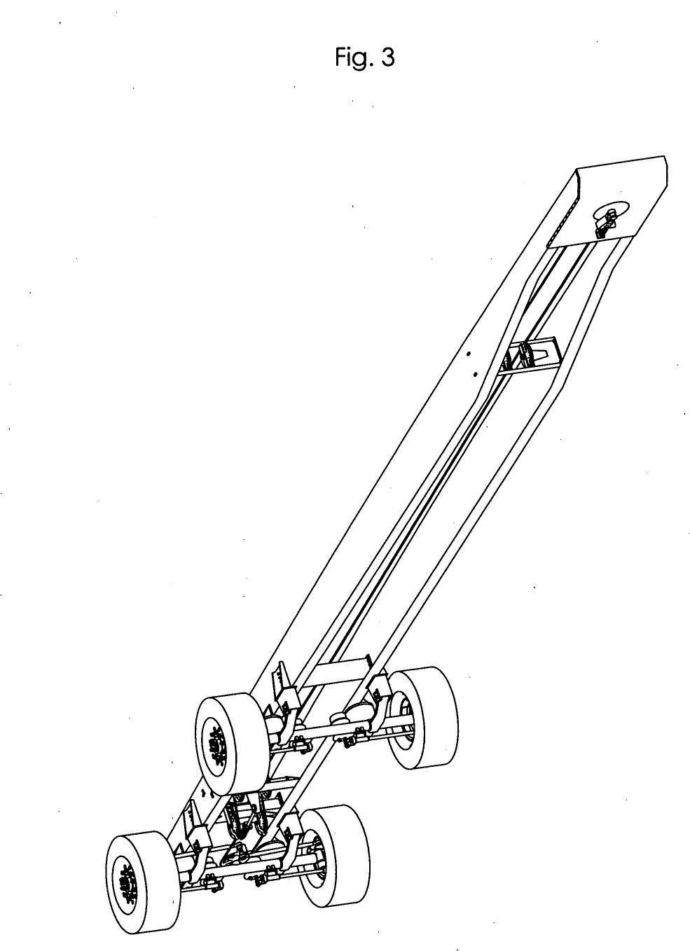

FIG. 4 shows a rear view of the trailer.

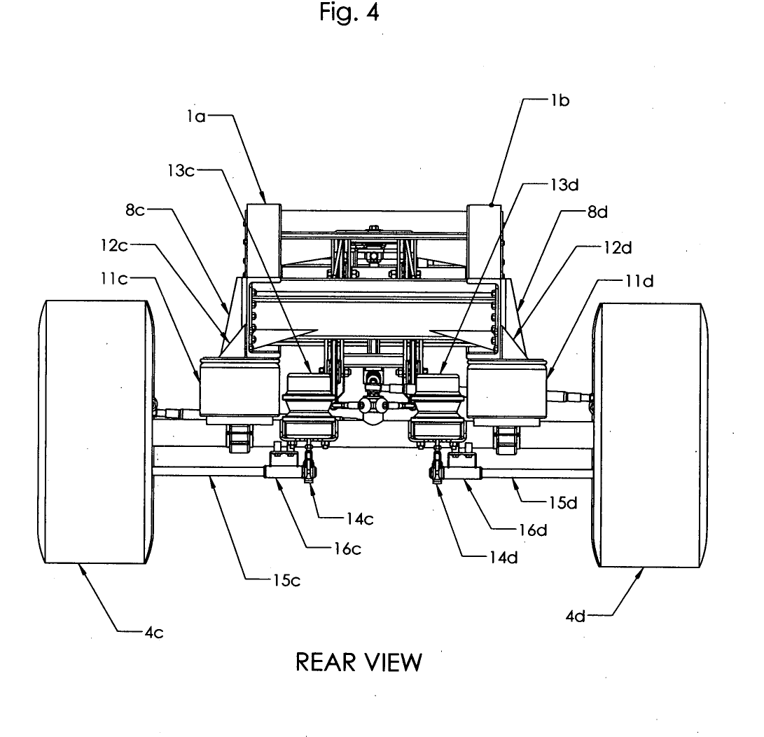

FIG. 5 shows an enlarged view of the steering mechanism for the steering axle, enlarged from FIG. 1.

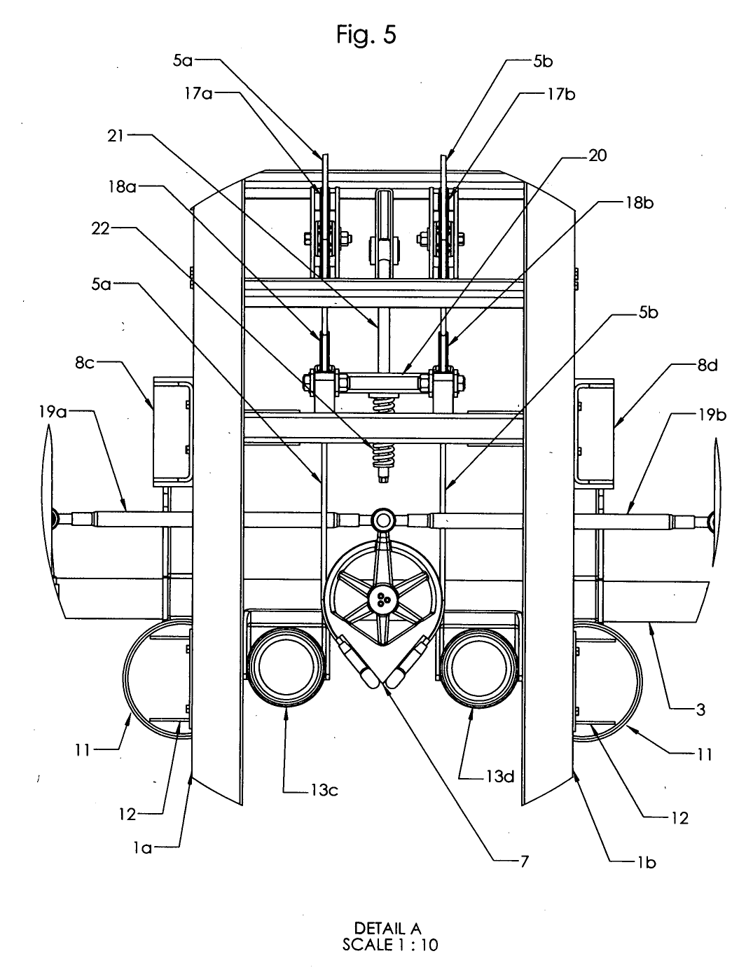

FIG. 6 shows a section view (B-B) taken from FIG. 1 showing the cam and keying mechanism as seen looking forward.

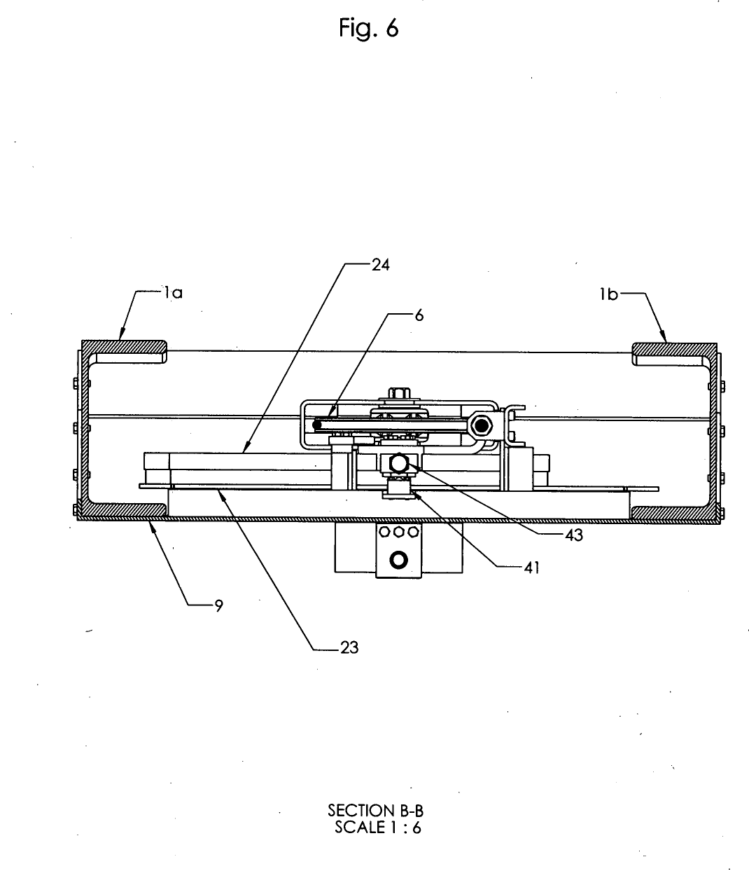

FIG. 7 shows the underside of the fifth wheel plate area, showing the keying mechanism.

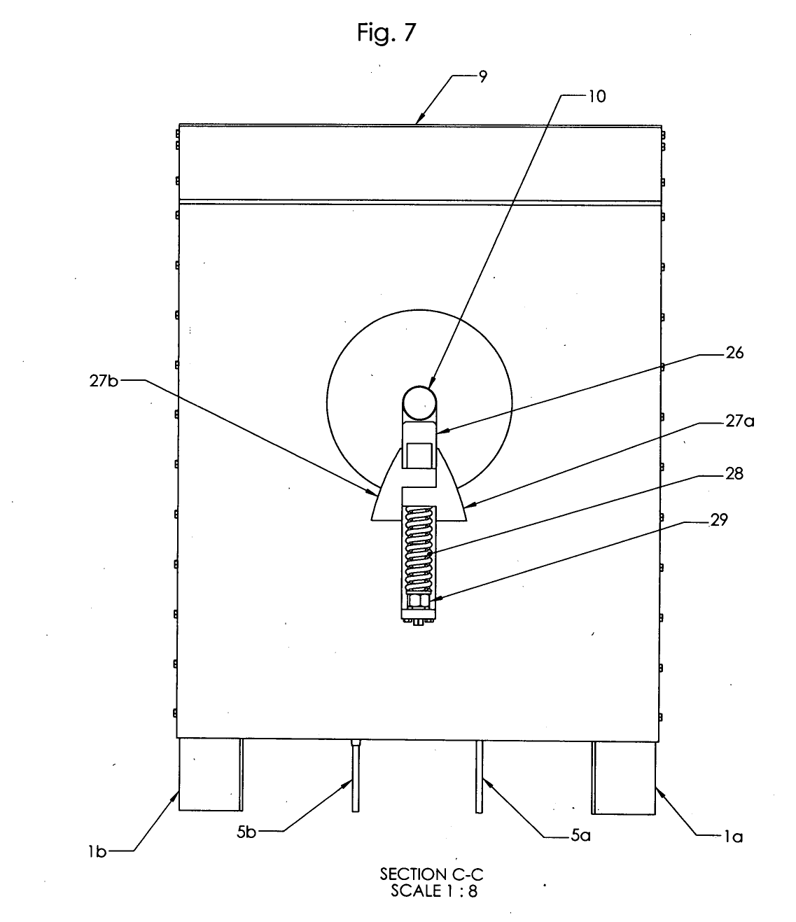

FIG. 8 shows the cable tensioning mechanism and the intermediate idler pulleys.

FIG. 9 shows a section (F-F) through a steerable wheel showing the universal joint in the brake cam shaft.

FIG. 10 shows a section (G-G) in front of the steerable axle showing the tie rod arrangement with the steering sector pulley.

FIG. 11 shows a section (H-H) through the fifth wheel kingpin, showing the cam, the cam followers, the front idler pulley, and the preload mechanism for the fifth wheel key, and a blowup view J showing details of the cam and cam followers.

FIG. 12 shows the fifth wheel cam and the air suspension release cam, the cam follower assembly, the front idler pulley and the steering cables.

FIG. 13 shows a perspective view of the same parts as FIG. 12.

### DRAWINGS—REFERENCE NUMERALS

Note: multiple instances of the same part are designated by letters; i.e. 1a, 1b, etc. Also note that items associated with the left front wheel (on the trailer) are always—a, items associated with the right front wheel are always—b, items associated with the left rear wheel are always—c, and items associated with the right rear wheel are always—d. Items that are on the left are always—a and items that are on the right are always—b.
1: Frame rail
2. Fixed axle
3. Steerable axle
4. Tire & wheel
5. Steering cable
6. Front idler pulley
7. Steering sector pulley
8. Axle pivot bracket
9. Kingpin plate
10. Kingpin
11. Suspension air bag
12. Air bag bracket
13. Spring brake canister
14. Brake slack adjuster
15. Brake cam shaft
16. Brake cam shaft support
17. Fixed tensioning pulley
18. Moving tensioning pulley
19. Tie rod
20. Cable tensioning arm
21. Tensioning rod
22. Tensioning spring
23. Suspension air release cam
24. Steering cam
25. Turntable
26. Key
27. Key wedge
28. Key wedge spring
29. Key wedge spring tensioning nut
30. Tensioning spring adjusting nut
31. Intermediate idler pulley
32. Brake drum
33. Brake shoe
34. Brake cam
35. Brake cam universal outer
36. Steering knuckle
37. Steering king pin
38. Wheel bearing
39. Wheel hub
40. O-ring
41. Suspension air release valve
42. Cam follower preload spring pack
43. Cam follower preload screw
44. Cam follower bearing
45. Cam follower pivot pin
46. Cam follower slider
47. Cam follower body
48. Cam follower retainer
49. Cam follower support
50. Frame cross member
51. Steering arm
52. Cam follower support bushing

### DETAILED DESCRIPTION-PREFERRED EMBODIMENT

The figures show the preferred embodiment consisting of a frame (1), as would be used for a flatbed trailer, and two axles spaced so as each would be rated as a single axle rather than a tandem pair, with the forward axle (2) fixed and the rear axle (3) steerable. The axles are suspended by independent air suspension, which is the standard suspension for spread axle trailers, since spring suspension would require long walking beams to accommodate road irregularities without overloading either axle. Note that the drawings do not show any details of the trailer not relevant to this invention, such as the trailer deck, landing gear, or anything else.

The trailer is connected to the tractor in the same manner as a conventional trailer with the exception that the key (26) engages the slot in the fifth wheel on the tractor, with the key wedges (27) forced into the slot by the key wedge spring (28) so that the key is centered in the slot and the kingpin (10) is forced to the forward part of the kingpin receptacle in the fifth wheel. This makes for a repeatable relationship between the key (26) and the fifth wheel; which leads to predictable alignment of the system. The spring force is adjusted by the key wedge spring tensioning nut (29). This leads to the only requirement for the tractor beyond what a normal trailer would require, and that is that the fifth wheel must be accurately aligned. A relatively simple fixture can easily be fabricated to do this; it is not necessary to include it as part of this invention as the design will be pretty obvious to anyone skilled in the art.

Once the trailer is connected to the tractor whenever the tractor turns relative to the trailer the key (26) and key wedges (27) cause the turntable (28) to stay parallel to the tractor, thereby causing said turntable to turn relative to the trailer. This causes the suspension release cam (23) and steering cam (24) to turn relative to the trailer as well, with the motion of said steering cam (24) to cause the cam follower body (47) to move which in turn causes the steering cables (5) to move as well. Said cam follower body (47) has two cam follower bearings (44), one rigidly connected to said cam follower body (47) by a cam follower pin (45). The other cam follower bearing is attached to a cam follower slider (46) also by a cam follower pin (45) and held against said steering cam by a cam follower preload spring pack (42) which consists of a stack of Belleville spring washers with pressure supplied by a cam follower preload screw (43). One steering cable is directed towards the front of the trailer and passes around the front idler pulley (6) and then continues to the steering mechanism, passing over intermediate idler pulleys (31) as necessary. The other steering cable passes directly to the steering mechanism, also passing over said idler pulleys.

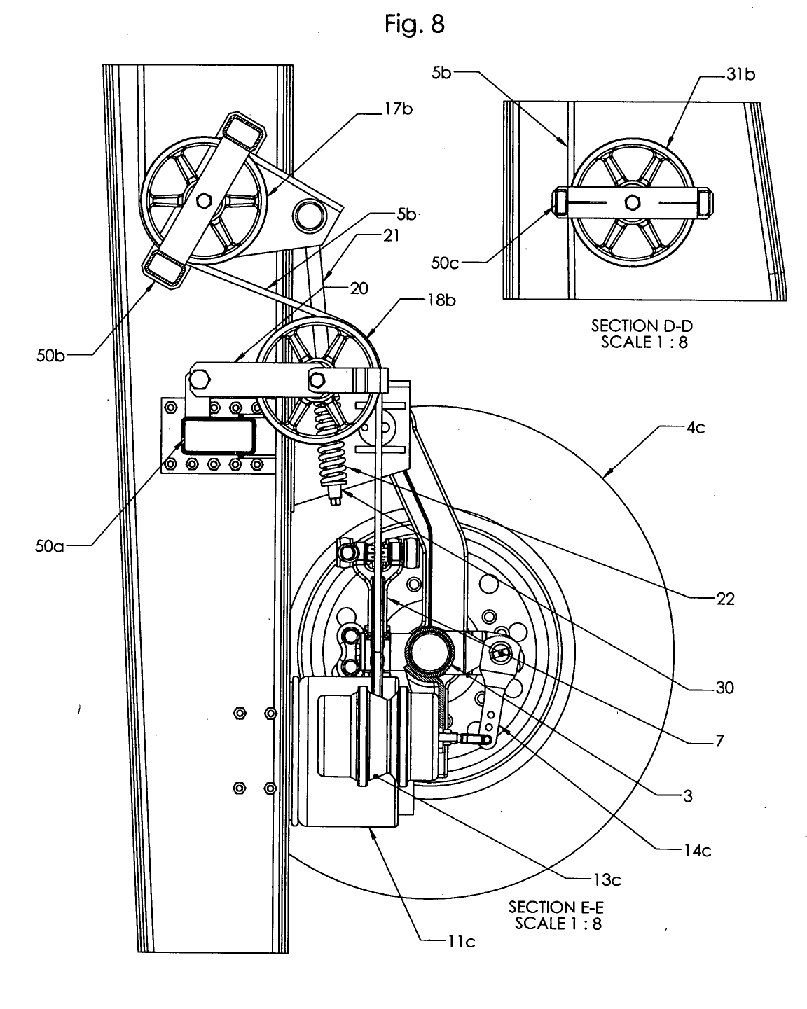

FIG. 8 shows the mechanism to keep the steering cables taut and synchronized in Section E-E. The cable tensioning arm (20) is pivoted on a frame cross member (50a) and carries two moving tensioning pulleys (18). Said steering cables (5) pass over two fixed idler pulleys (17) mounted to another frame crossmember (50b). Said second crossmember also carries the pivot for the tensioning rod (21) which carries the spring (22) which applies pressure to said cable tensioning arm (20) by utilizing the tensioning spring adjusting nut (30). This figure in section D-D also shows the intermediate idler pulleys (31) attached to another crossmember (50c) used to prevent said cables from getting entangled in anything due to excessive unsupported length.

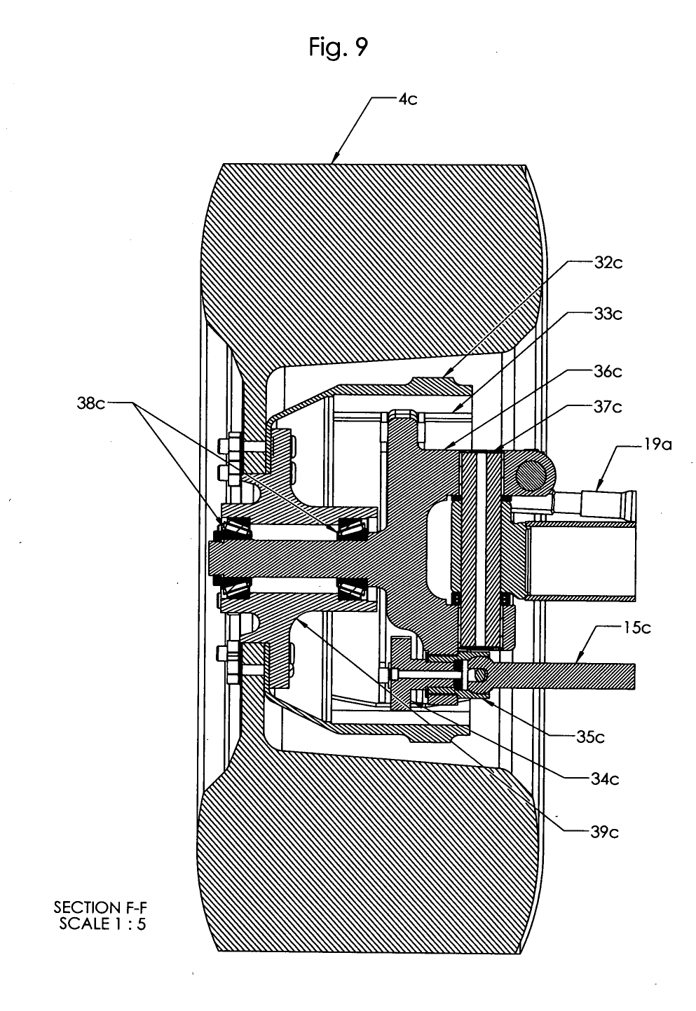

FIG. 9 shows a section through the left rear steerable wheel. For the sake of simplicity the steering kingpin (37c) is shown vertical; in actual use said kingpin would be inclined to line up as close as possible with the center of the tire (4c) where said tire contacts the ground. This figure shows the brake cam (34c), the brake cam universal outer (35c), and the brake cam shaft (15c). Said brake cam shaft (15c) is also the inner part of said universal joint, which enables the spring brake canister (13c) to be mounted inboard out of the way of the turning tire (4c). This figure also shows the wheel hub (39c), the steering knuckle (36c), the wheel bearings (38c), and the brake drum (32c).

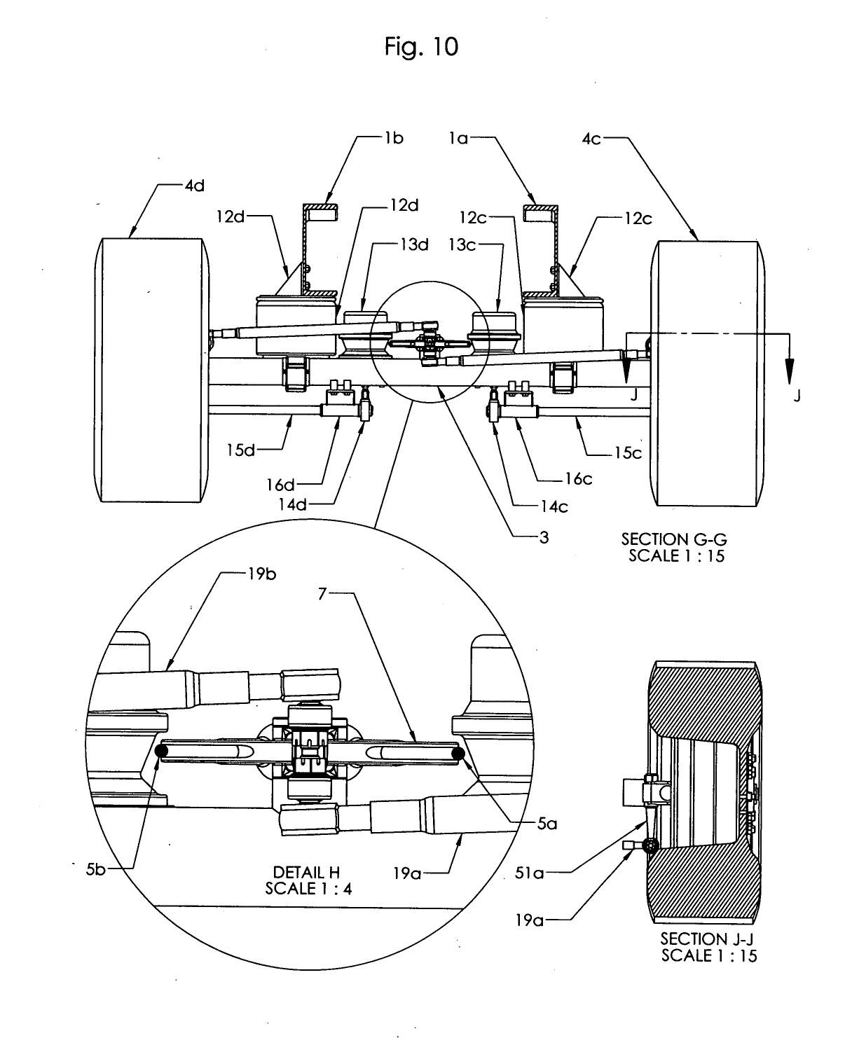

FIG. 10 shows Section G-G which illustrates the preferred embodiment of the tie rods. The advantage of this arrangement is that both steering arms are identical, as are both tie rods. The steering force has exactly the same path to both the left and right wheels, so there is less chance of unequal movement causing patterned wear on the tires. Looking at Detail H one sees said steering sector (7) and tie rods (19a) and (19b). By having one tie rod end mounted above said steering sector (7) and one below this allows said steering cables (5) to clear both tie rods and simulate a single tie rod actuated from the center. Having both tie rod ends mounted on the same plane is also possible, but the steering geometry is more complicated, and would preclude using the same part for both steering arms (51). Section J-J illustrates said steering arm (51a) and said tie rod (19a).

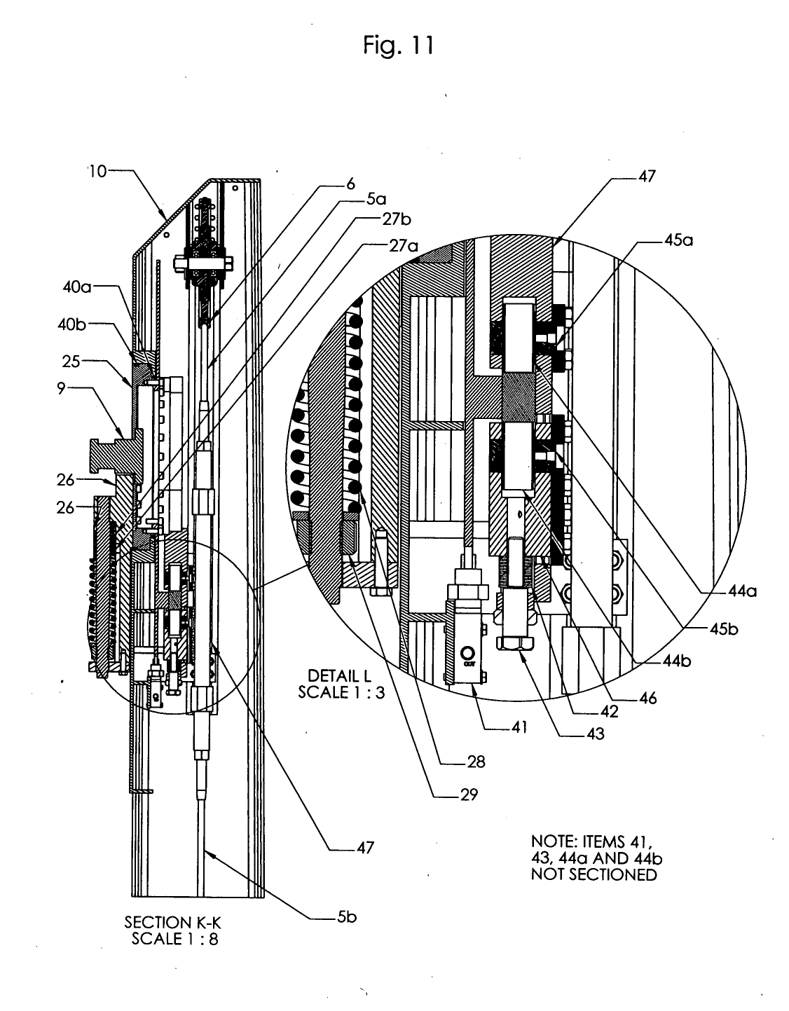

FIG. 11 shows Section K-K through said turntable(25) and said steering cam (24) with said cam follower bearings (44), showing the cam follower preload screw (43), cam follower slider (46), cam follower body (47), and cam follower spring preload pack (42). Said cam follower spring preload pack consists of dished spring washers known as belleville washers, which have the advantage of being able to provide very high force in a compact package at the cost of very short travel, which is exactly what is required in this instance.

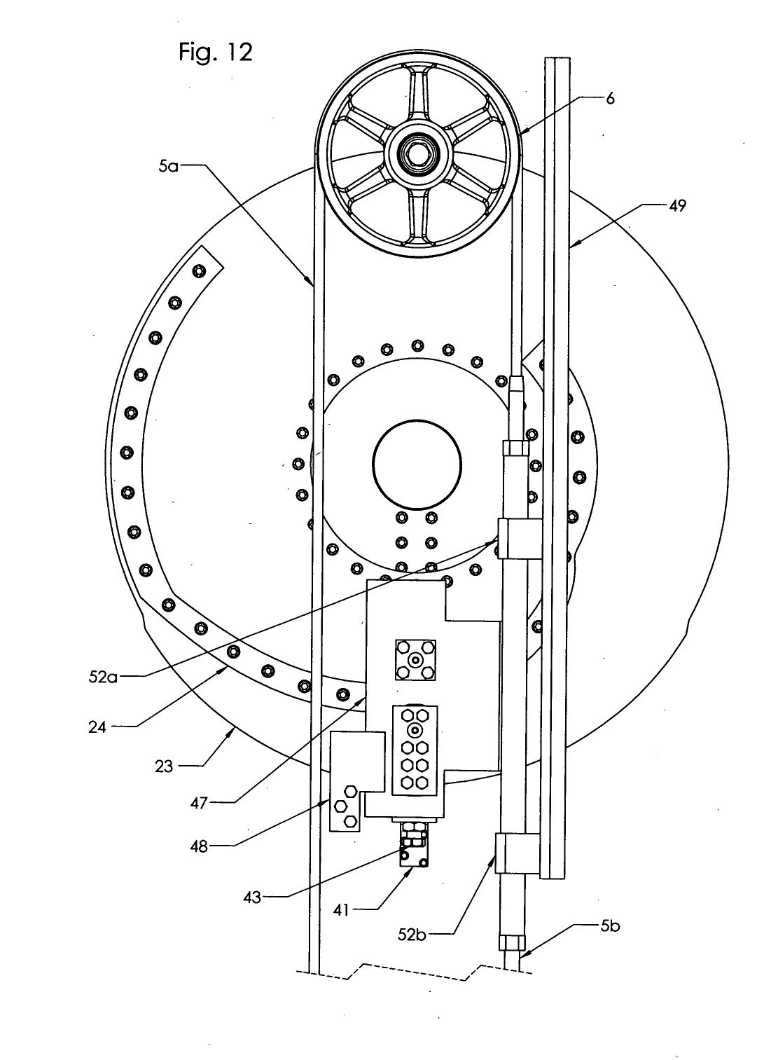

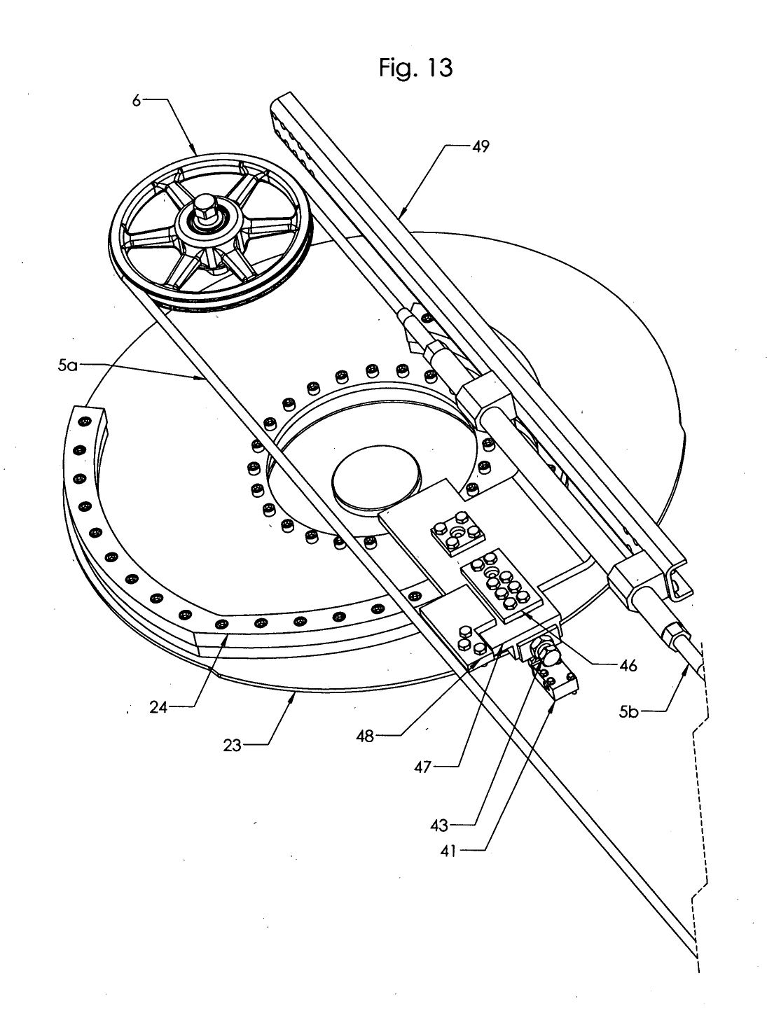

FIG. 12 shows a plan view of said steering cam (24), turntable (25), suspension air release cam (23), front idler pulley (6), cam follower body (47), cam follower support bushings (52), and steering cables (5). Note that said cam follower body is retained by the cam follower retainer (48) which prevents said cam follower body from rotating in said cam follower support bushings and,disengaging said cam follower bearings (44) from said steering cam (24). FIG. 13 shows exactly the same parts in a perspective view; this shows said suspension air release valve (41) more clearly.

I claim:

1. A turntable for the kingpin of a truck semitrailer which is keyed to the tractor fifth wheel and thereby turns with the tractor to give a mechanical reference for the angle between said tractor and said trailer
a A keying mechanism for keying said turntable to said fifth wheel comprising of two wedges, a spring, a threaded shaft, and a nut, whereby said wedges are pressed by said spring into the space between a fixed key attached to said turntable and the tapered slot in said fifth wheel, said wedges and said spring being guided by said threaded shaft and retained and pressure adjusted by said nut.
b. One or more cams attached to or coupled to said turntable which has or have a contour calculated to steer one or more steerable axles on said semitrailer so as to cause said steerable axle or axles to follow the same track as a fixed, i.e. non-steerable axle until the steering limit of said steerable axle or axles is reached, and then stay at that angle.
c. Means to connect said steerable axle or axles with said cam or cams such that the displacement of said cam or cams is accurately transmitted to the steering arms of said axle or axles. The preferred embodiment of this invention uses cables, but any means, be it mechanical, electrical, hydraulic, or other means falls within the scope of this invention.
d. A cam attached to said turntable which operates an air valve at the point at which one cam of claim 1b reaches the point at which said steerable axle reaches its steering limit to cut off the air supply to the suspension of said steerable axle.

2. An air brake cam shaft with a universal joint so that said universal joint is located on the extended axis of said steerable axle's kingpin, enabling the air brake operating canister to be located away from said steerable axle's wheel and thus not interfering with the frame or suspension of said semitrailer.

3. A steering mechanism for a steerable axle comprising of an actuating arm with pivot points directly over each other in the plane of the pivot axis of said actuating arm, and with the actuating length of said actuating arm equal to the length of the arms of each steerable wheel, allowing said steering arms on said steerable wheels to be connected to said actuating arm with two tie rods giving the same effect as a single tie rod.
